(19) United States
(12) Patent Application Publication
(10) Pub. No.: US 2011/0014860 A1
(43) Pub. Date: Jan. 20, 2011

(54) FRONT FOOT AIR VENT FOR AUTOMOBILE

(75) Inventor: Byung Seok KONG, Gunpo-si (KR)

Correspondence Address: MORGAN, LEWIS & BOCKIUS LLP (SF), One Market, Spear Street Tower, Suite 2800, San Francisco, CA, 94105, US

(73) Assignee: Kia Motors Corporation, Seoul (KR)

(21) Appl. No.: 12/616,554

(22) Filed: Nov. 11, 2009

(30) Foreign Application Priority Data
Jul. 16, 2009 (KR) 10-2009-0065071

(51) Int. Cl. B60H 1/24

(52) U.S. Cl. 454/143

(57) ABSTRACT

A front foot air vent for an automobile may include a center support bracket disposed between a console side cover and an air duct and provided with a through hole, wherein a discharge hole of the console side cover, a passage of the air duct and the through hole of the center support bracket are communicated with one another; and a grill member which is formed as a separate piece and includes an air passage therein, wherein the grill member is assembled to the discharge hole, the through hole and the passage so as to be communicated between the discharge hole of the console side cover and the passage of the air duct through the air passage of the grill member.

### CROSS-REFERENCE TO RELATED APPLICATION

This application claims priority to Korean Patent Application No. 10-2009-0065071 filed in the Korean Intellectual Property Office on Jul. 16, 2009, the entire contents of which are incorporated herein for all purposes by this reference.

### BACKGROUND OF THE INVENTION

1. Field of the Invention

The present invention relates to a front foot air vent for an automobile, and more particularly to a front foot air vent for an automobile which is connected to an air conditioning device of an automobile and is positioned under a center support bracket in front of a driver seat and a front passenger seat.

2. Description of Related Art

Generally, an air conditioning device of an automobile is configured to introduce outside air into a cabin to cool or heat the cabin or to ventilate air inside the cabin to make the cabin comfortable.

A foot air vent is integrally formed on a surface of a console side cover which is positioned at a lower end of a center support bracket which is positioned in front of a driver seat and a front passenger seat, and allows cooled or heated air to be discharged toward front passengers including a driver.

However, as shown in FIG. 3 and FIG. 4, in order that the center support bracket 100 and the foot air vent 400 do not interfere with one another, the center support bracket 100 is formed to be protruded toward the rearward of an automobile to be bended.

Thus, the rigidity support force of the center support bracket 100 is deteriorated, and NVH characteristic of steering is also deteriorated.

In addition, since the center support bracket 100 is designed to be bended toward the rearward of an automobile, there is a problem that the center support bracket 100 may interfere with a console main cover 250 which is positioned between a driver seat and a front passenger seat.

Meanwhile, a console side cover 200 to which the foot air vent 400 is integrally formed and the console main cover 250 are separately formed and are then coupled together because of discrepancy of mold angle of a direction change blade of the foot air vent 400 and the console main cover 250.

At this time, the discrepancy of mold angle means that when separating the forming mold after forming separation directions of forming molds of the console side cover 200 and the console main cover 250 are not coincided with one another because of slant angle of the direction change blade which is provided to the foot air vent 400.

As such, the console side cover 200 and the console main cover 250 can not be integrally formed because of the discrepancy of the mold angle, and instead are separately formed and are then coupled to one another, so manufacturing cost is increased.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a front foot air vent for an automobile in which a center support bracket is provided at a passage of an air duct to be communicated with a foot air vent so that a front surface of a console can be closer to an instrument panel, thereby enhancing degree of freedom of design of the console and improving NVH characteristics of the steering device, and furthermore the console side cover and the console main cover are integrally formed and a grill member which is coupled to an air ventilation hole is separately formed so as to reduce manufacturing cost than a prior art in which a console cover is separately formed.

In an aspect of the present invention, a front foot air vent for an automobile may include a center support bracket disposed between a console side cover and an air duct and provided with a through hole, wherein a discharge hole of the console side cover, a passage of the air duct and the through hole of the center support bracket are communicated with one another; and a grill member which is formed as a separate piece and includes an air passage therein, wherein the grill member is assembled to the discharge hole, the through hole and the passage so as to be communicated between the discharge hole of the console side cover and the passage of the air duct through the air passage of the grill member.

The discharge hole of the console side cover, the passage of the air duct and the through hole of the center support bracket may be coaxially aligned.

The grill member may include a front surface portion configured to be mounted on the discharge hole of the console side hole; a communication portion which extends from the front surface portion and includes the air passage therein, wherein the communication portion is engaged with the passage of the air duct by passing through the through hole of the center support bracket and a direction change blade is provided in the air passage; and a locking protrusion which is provided to an end portion of the communication portion and is locked to an end of the passage of the air duct.

The locking protrusion may be a hook.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a drawing showing a structure of a cabin around a front foot air vent for an automobile according to an exemplary embodiment of the present invention.

FIG. 2 is a sectional view along a line A-A of FIG. 1.

FIG. 3 is a drawing showing a structure of a cabin around a conventional front foot air vent for an automobile.

FIG. 4 is a sectional view along a line B-B of FIG. 3.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Various exemplary embodiments of the present invention will hereinafter be described in detail with reference to the drawing.

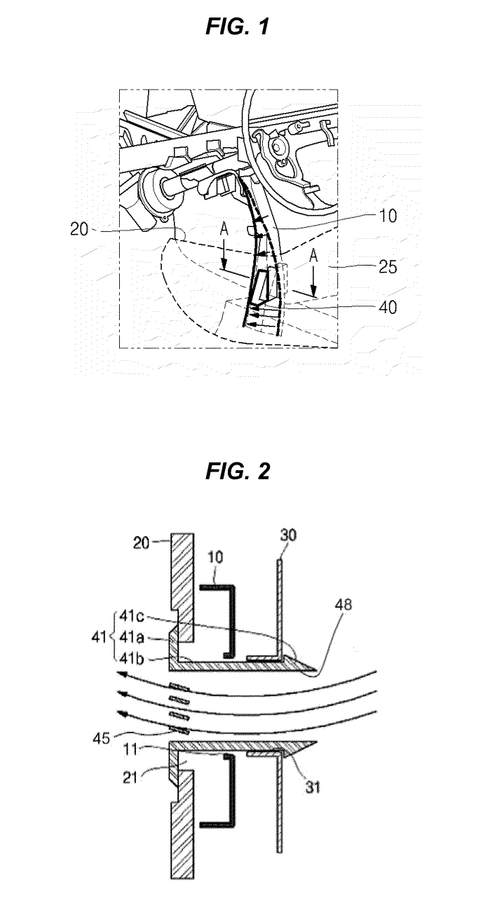

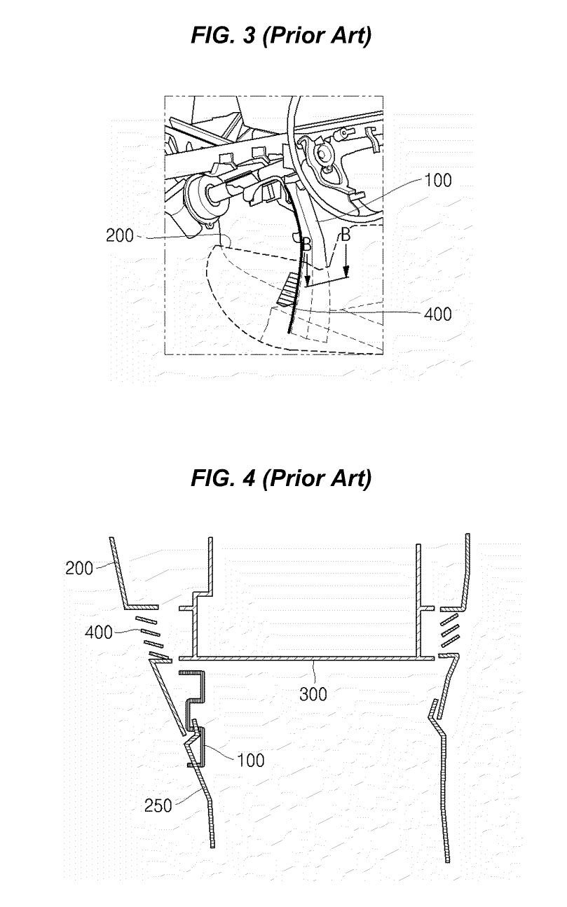

FIG. 1 is a drawing showing a structure of a cabin around a front foot air vent for an automobile according to an exemplary embodiment of the present invention, and FIG. 2 is a sectional view along a line A-A of FIG. 1.

According to an exemplary embodiment of the present invention, as shown in FIG. 1, a foot air vent 40 is formed at a console side cover 20 which is positioned at a side of a center fascia panel and is configured to wrap a center support bracket 10 supporting a steering device connected to a steering wheel of an automobile.

At this time, positions of an air duct 30 and the foot air vent 40 which are connected to an air conditioner of an automobile are not different from a prior art, but the center support bracket 10 is positioned to coincide with a passage where cooled or heated air generated by an air conditioner flows.

That is, as shown in FIG. 2, a surface of the center support bracket 10 and a discharge hole 21 of the console side cover 20 are coincided to correspond to one another, and the discharge hole 21 and the center support bracket 10 corresponding with the same are formed to communicate with the air duct 30.

At this time, a through hole 11 which is coincided with the discharge hole 21 and a passage 31 of the air duct 30 is formed on the surface of the center support bracket 10 which is disposed between the discharge hole 21 of the console side cover 20 and the passage 31 of the air duct 30, such that the discharge hole 21 of the console side cover 20 and the passage 31 of the air duct 30 are coincided with one another.

As such, that the discharge hole 21 of the console side cover 20 and the through hole 11 of the center support bracket 10 are maintained to be coincided with one another denotes that the center support bracket 10 is moved toward the center fascia panel, that is, toward the front of an automobile, when compared to a prior art.

Accordingly, this causes the shape of being slanted toward the rearward of an automobile by a predetermined angle of the center support bracket 10 which is extended along a boarder surface of the center fascia panel to move forward, thereby being arranged vertically in a downward direction of the center fascia panel so that support force against a floor of an automobile, so the rigidity support force of the center support bracket 10 is enhanced and NVH characteristics of steering is also improved.

Furthermore, by changing the position of the center support bracket 10 as such, interference with a console main cover 25 which is positioned at the same position with the prior art may be avoided, when compared to the prior art.

Furthermore, according to an exemplary embodiment of the present invention, a conventional grill member which is integrated with the foot air vent 40 is eliminated, and a grill member 41 is formed at the discharge hole 21 of the foot air vent 40.

Accordingly, a problem of discrepancy of mold angle between the console side cover 20 and the console main cover 25 can be solved, so the console side cover 20 and the console main cover 25 can be integrally formed.

The grill member 41 of the foot air vent 40 which is separately connected to the discharge hole 21 of the console side cover 20, as shown in FIG. 2, is formed to be able to be fitted to an end of the passage 31 of the air duct 30 using a locking protrusion 41c in a state that the discharge hole 21 of the console side cover 20 and the through hole 11 of the center support bracket 10 are coincided.

That is, as shown in the drawing, the grill member 41, which is a separate piece, includes a front surface portion 41a which is provided with a direction change blade 45, a communication portion 41b which is extended rearward from the front surface portion 41a and includes an air passage 48 therein to allow air flow therethrough and is fixedly fitted into the discharge hole 21 of the console side cover 20 and the through hole 11 of the center support bracket 10, and a locking protrusion 41c which is provided to an end of the communication portion 41b and is hooked to an end of the passage 31 of the air duct 30.

Accordingly, according to an exemplary embodiment of the present invention, the center support bracket 10 is positioned between the discharge hole 21 of the console side cover 20 and the passage 31 of the air duct 30 to cause the center support bracket 10 to be vertical, thereby enhancing degree of freedom of design of the console and improving NVH characteristics of the steering device.

Furthermore, the through hole 11 is formed on a surface of the center support bracket 10 such that the discharge hole 21 and the passage 31 are communicated to one another, and the grill member 41 which is a separate piece can be assembled to the discharge hole 21, the through hole 11, and the passage 31.

Accordingly, the grill member 41 which has a complicated shape can be separately manufactured, and the console side cover 20 and the console main cover 25 which have relatively simple bracket shapes can be integrally formed.

As described above, according to a front foot air vent for an automobile according to the present invention, the center support bracket is positioned between the discharge hole of the console side cover and the passage of the air duct to cause the center support bracket to be vertical so that a front surface of the console can be closer to the instrument panel, thereby enhancing degree of freedom of design of the console and improving NVH characteristics of the steering device.

Furthermore, the grill member is formed as a separate piece, so the console side cover and the console main cover which are formed as a simple bracket shape can be integrally formed, and therefore manufacturing cost thereof can be reduced when compared to the method that they are formed as separate members.

For convenience in explanation and accurate definition in the appended claims, the term “rearward” is used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A front foot air vent for an automobile comprising:
a center support bracket disposed between a console side cover and an air duct and provided with a through hole, wherein a discharge hole of the console side cover, a passage of the air duct and the through hole of the center support bracket are communicated with one another; and
a grill member which is formed as a separate piece and includes an air passage therein, wherein the grill member is assembled to the discharge hole, the through hole and the passage so as to be communicated between the discharge hole of the console side cover and the passage of the air duct through the air passage of the grill member.

2. The front foot air vent of claim 1, wherein the discharge hole of the console side cover, the passage of the air duct and the through hole of the center support bracket are coaxially aligned.

3. The front foot air vent of claim 1, wherein the grill member comprises:
a front surface portion configured to be mounted on the discharge hole of the console side hole;
a communication portion which extends from the front surface portion and includes the air passage therein, wherein the communication portion is engaged with the passage of the air duct by passing through the through hole of the center support bracket and a direction change blade is provided in the air passage; and
a locking protrusion which is provided to an end portion of the communication portion and is locked to an end of the passage of the air duct.

4. The front foot air vent of claim 3, wherein the locking protrusion is a hook.
